(19) United States
(12) Patent Application Publication
(10) Pub. No.: US 2008/0010602 A1
(43) Pub. Date: Jan. 10, 2008

(54) INDEPENDENT IMAGE FOR MOBILE DEVICE GRAPHIC USER INTERFACE

(76) Inventor: Richard Redpath, Cary, NC (US)

Correspondence Address: HOFFMAN WARNICK & DALESSANDRO LLC, 75 STATE ST, 14TH FLOOR, ALBANY, NY, 12207, US

(21) Appl. No.: 11/428,877

(22) Filed: Jul. 6, 2006

(51) Int. Cl. G06F 9/00

(52) U.S. Cl. 715/764; 715/864; 715/835; 715/838

(57) ABSTRACT

A method, system and program product for managing a mobile device graphic user interface (GUI) image that allows for an independent image, such as a “floating” logo, is disclosed. The method for managing the image, such as a logo, on a mobile device graphic user interface (GUI), includes providing a mobile device GUI, wherein the mobile device GUI is configurable to display at least one of a background image and an application image; and displaying an independent image on the mobile device GUI in one of a plurality of pre-defined, user-selectable areas, wherein the independent image is independent of any background image and any application image (e.g., “floats”).

### BACKGROUND OF THE INVENTION

1. Field of the Invention

The present invention relates generally to mobile devices and graphic user interfaces (GUI) thereof. More specifically, the present invention provides a method, system, and computer program product for managing a mobile device graphic user interface (GUI) image that allows for an independent image, such as a “floating” logo.

2. Background Art

In the field of electronic network communications mobile devices, such as mobile phones, personal device assistant (PDAs), and the like are increasingly popular. With the increased use of mobile devices has been a concomitant increase in the various applications that are available and can be run on mobile devices and displayed on the GUI.

These various mobile device applications are typically designed by mobile service providers or enterprise software customers so as to deliver information and/or provide functionalities to the end user. Typically, the various applications are custom designed for a specific mobile device and its particular respective GUI configuration and characteristics. That is the background and logo for that particular application is either designed to “form fit” a particular mobile device or the logo is programmatically overlaid to the individual application's background. As a result, amongst other shortcomings, the mobile service provider's logo will not necessarily be shown depending on what enterprise application is being run on the mobile device and being displayed on the GUI. The display of the logo on the GUI is intertwined with the particular mobile device and GUI and the particular application developed to run on the mobile device.

In view of the foregoing, a need exists to overcome one or more of the deficiencies in the related art.

### SUMMARY OF THE INVENTION

In general, the present invention provides a method, system and program product for managing a mobile device graphic user interface (GUI) image that allows for an independent image, such as a “floating” logo, is disclosed. The method for managing the image, such as a logo, on a mobile device graphic user interface (GUI), includes providing a mobile device GUI, wherein the mobile device GUI is configurable to display at least one of a background image and an application image; and displaying an independent image on the mobile device GUI in one of a plurality of pre-defined, user-selectable areas, wherein the independent image is independent of any background image and any application image (e.g., “floats”).

A first aspect of the present invention provides a method of managing a mobile device graphic user interface (GUI) image, the method comprising: providing a mobile device GUI, wherein the mobile device GUI is configurable to display at least one of a background image and an application image; and displaying an independent image on the mobile device GUI in one of a plurality of pre-defined, user-selectable areas, wherein the independent image is independent of the background image and the application image.

A second aspect of the present invention provides a system of managing a mobile device graphic user interface (GUI) image, the system comprising: a mobile device GUI, wherein the mobile device GUI is configurable to display at least one of a background image and an application image; and a system for displaying an independent image on the mobile device GUI in one of a plurality of pre-defined, user-selectable areas, wherein the independent image is independent of the background image and the application image.

A third aspect of the present invention provides a program product stored on a computer readable medium for managing a mobile device graphic user interface (GUI) image, the computer readable medium comprising program code configured to: display an independent image on a mobile device GUI in one of a plurality of pre-defined, user-selectable areas, wherein the mobile device GUI is configurable to display at least one of a background image and an application image, and wherein the independent image is independent of the background image and the application image.

A fourth aspect of the present invention provides a method for deploying an application for managing a mobile device graphic user interface (GUI) image, comprising: providing a computer infrastructure being operable to: display an independent image on a mobile device GUI in one of a plurality of pre-defined, user-selectable areas, wherein the mobile device GUI is configurable to display at least one of a background image and an application image, and wherein the independent image is independent of the background image and the application image.

A fifth aspect of the present invention provides computer software embodied in a propagated signal for managing a mobile device graphic user interface (GUI) image, the computer software comprising instructions to cause a computer system to perform the following: displaying an independent image on a mobile device GUI in one of a plurality of pre-defined, user-selectable areas, wherein the mobile device GUI is configurable to display at least one of a background image and an application image, and wherein the independent image is independent of the background image and the application image.

Therefore, the present invention provides a method, system, and a computer program product for managing a mobile device graphic user interface (GUI) image that allows for an independent image, such as a “floating” logo.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a pictorial of a mobile device, in accordance with an embodiment of the present invention.

FIG. 2A depicts a first mobile device graphic user interface (GUI), in accordance with a first embodiment of the present invention.

FIG. 2B depicts a second mobile device graphic user interface (GUI), in accordance with an embodiment of the present invention.

FIG. 3A depicts a first mobile device, in accordance with an embodiment of the present invention.

FIG. 3B depicts a second mobile device, in accordance with an embodiment of the present invention.

FIGS. 4 depicts an exploded perspective view of a first image on a GUI, in accordance with an embodiment of the present invention.

FIG. 5 depicts a computerized system for managing a mobile device graphic user interface (GUI) image that allows for a “floating” logo, in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As indicated above, the present invention provides a method, system and program product for managing a mobile device graphic user interface (GUI) image that allows for a “floating” logo.

The present invention provides for a method for a default logo overlay to be used on any installed applications on the device. Further, the present invention includes an embodiment that enables the application to provide the logo overlay thereby overriding any default logo overlay, that may exist. Further, the present invention provides a means for a logo overlay that is independent of any background image that is used.

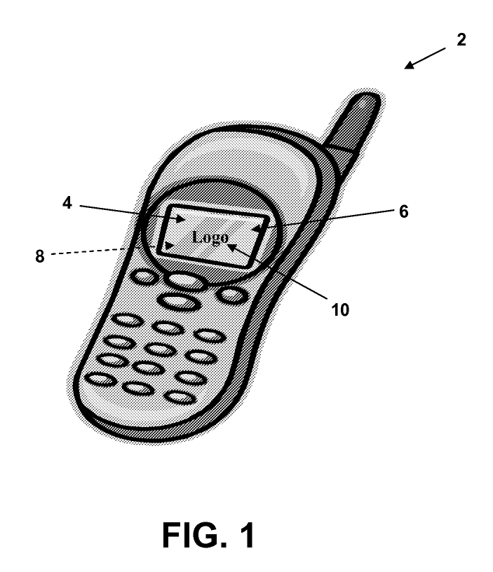

Turning to the figures, a pictorial of a mobile device 2 is depicted in FIG. 1. Included with the mobile device 2 is a graphic user interface (GUI) 4 which may display, for example a background 6, an application 8, and a first image 10 such as a logo.

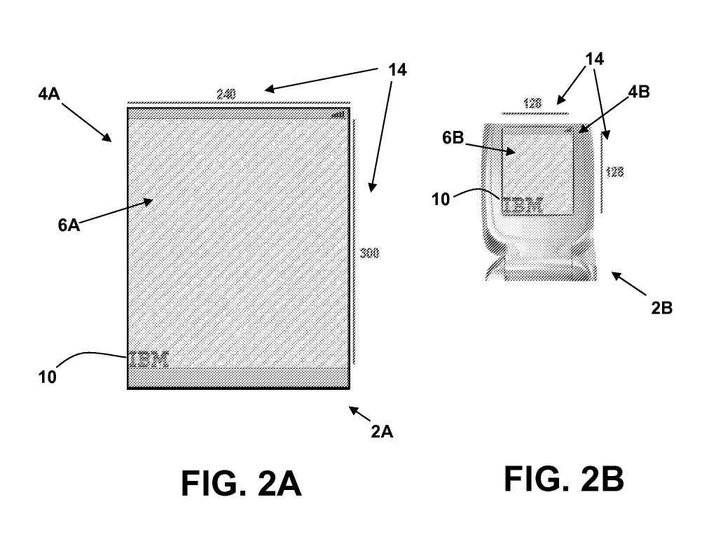

As shown in FIGS. 2A and 2B, two or more mobile devices 2A-B may, for example, have different size and types of GUIs 4A-B. The first mobile device 2A having a first GUI 4A may have a different (e.g., larger) size than the second GUI 4B of the second mobile device 2B. For example, the first GUI 4A may have side dimensions 14 having a 240 pixels×300 pixels resolution, while the second GUI 4B may have side dimensions 14 having a 128 pixels×128 pixels resolution.

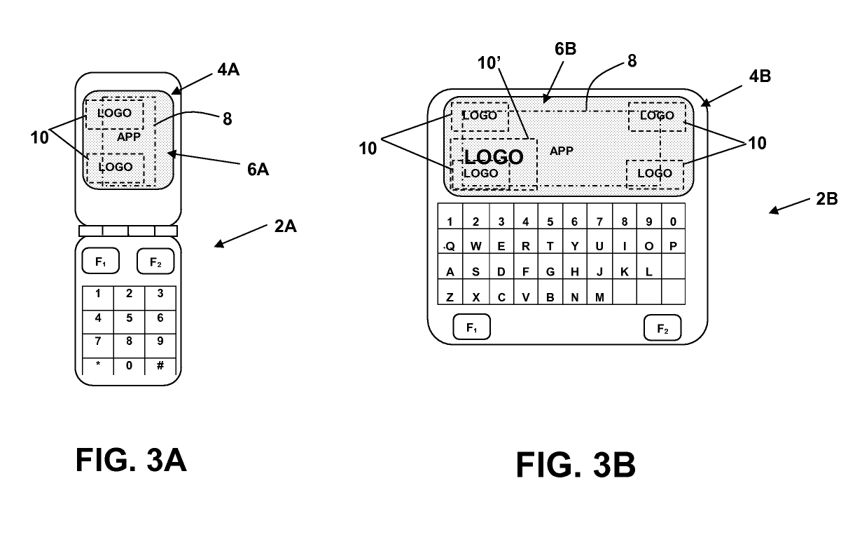

As depicted, the size of the first image 10 is independent of the size and type of the background 6A-B. Similarly, the first image 10 is independent of the mobile device 2A-B. That is, the same first image 10 may be used, without the need for adjustment, modifications, and/or the like, with different mobile devices 2A-B. For example, the first image 10 may be suitable both for a GUI 4 of a particular cell phone, manufactured by Nokia (not shown), and for a GUI 4 of a particular personal digital assistant (PDA), manufactured by Blackberry (not shown). As such, the first image 10 “floats” independently with respect to the GUI 4A-B and the background 6A-B. Additionally, the first image 10 is displayed independently of any application 8 (e.g., a service application shown in FIGS. 3A and 3B) that may be running and displayed on the GUI 4A-B.

The first image 10 may be any glyph, wherein the term glyph includes text, a graphical depiction, or a combination of both. The first image 10 may, for example, be a logo for a service provider, an enterprise application, or the like.

As FIGS. 3A and 3B show, an aspect of the first image 10 may be user adjustable and/or user selectable. The aspect may include a size of the first image 10 and/or a location of the display, or placement criteria, of the first image 10 upon the GUI 4. As shown in FIG. 3A, the first image 10 may be set by the user to display either in the upper left or upper right portion of the GUI 4A. As shown in FIG. 3B, the first image 10 may be set to display in at least one of a plurality of predefined, user-selectable locations or areas. For example, the predefined, user-selectable area may be either in the upper left, upper right, lower left, lower right portion of the GUI 4B. Similarly, the first image 10 will appear on the GUI 4A, 4B, independent of the type and size of GUI 4A, 4B; independent of the type of background image 6A, 6B; and, independent of any application 8 that may (or may not) be displayed on the GUI 4A, 4B. Clearly, other predefined, user-selectable areas for placement of the first image 10 on the GUI 4 are available under the present invention. Similarly, as shown in FIG. 3B, the first image 10′ may be adjusted to a larger size from the first image 10 so as to, for example, more suitably match the particular GUI 4B. It should be apparent to one skilled in the art that other sizes, placement locations, and other aspects are available to the user for adjustment than those depicted in FIGS. 3A and 3B without departing from the intent of the present invention.

The application 8 may, for example, be provided by a service provider. Examples of service providers include entities that provide telephone, mobile phone, internet access, and/or the like. Application 8 may provide functions such as for sending/receiving electronic mail (e-mail), text messaging, chat messaging, downloadable phone tones.

The background 6 may be any visual graphic that appears on the GUI 4. The first image 10 may display in front of the background 6. Further, if an application 8 is running and displaying on the GUI 4, the first image 10 may also display in front of the application 8. The first image 10 thereby “floats” in front of either, or both, the background 6 and application 8. As a result, the first image 10 is independent of the background 6 and application 8.

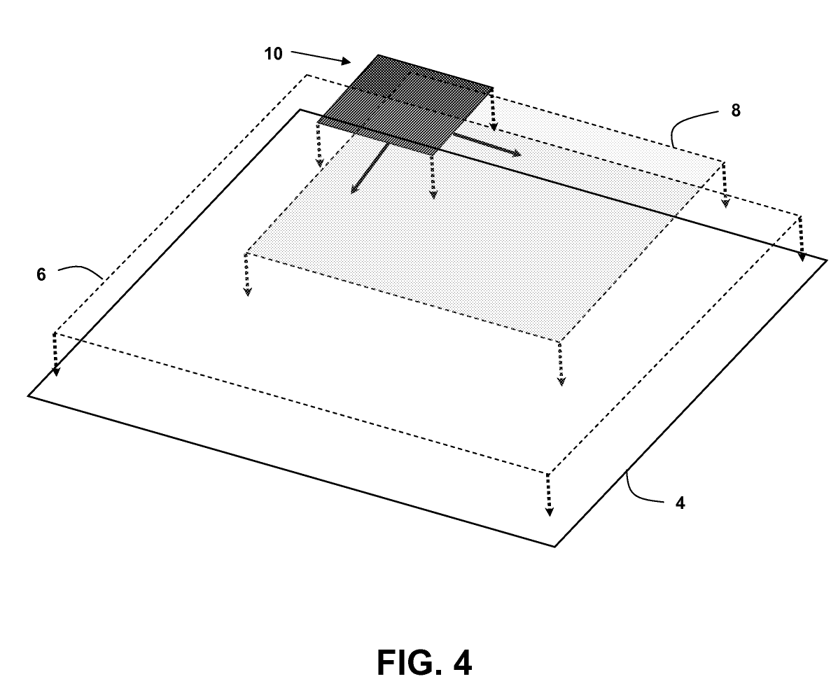

As FIG. 4 shows in exploded perspective view, the first image 10 may display anywhere on the GUI 4 and independent of what type of GUI 4 is employed. The first image 10 may display independent of what type of background 6 is displayed on the GUI 4. The first image 10 may display independent of what type of application 8 is displayed on the GUI 4.

The present invention ultimately provides a method, system, and computer program product for managing a mobile device graphic user interface (GUI) image that allows for an independent image, such as a “floating” logo.

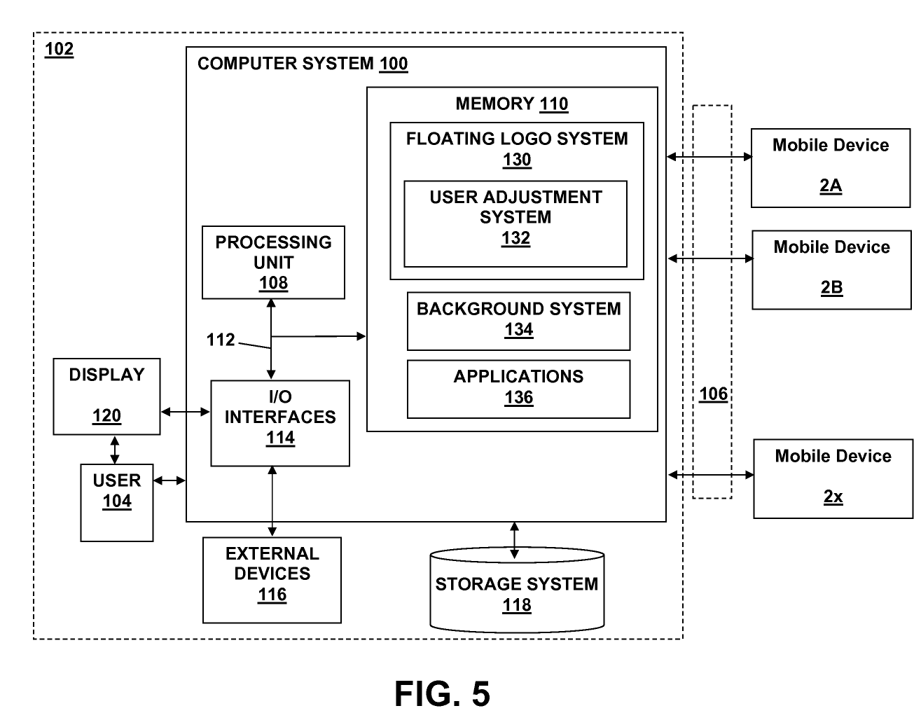

FIG. 5 shows a computer system 100 for managing a mobile device graphic user interface (GUI) image that allows for a “floating” logo, in accordance with an embodiment of the present invention. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for managing a mobile device graphic user interface (GUI) image that allows for a “floating” logo, in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as a Floating Logo System 130, which is stored in memory 110 and/or storage system(s) 118. While executing computer program code, processing unit 108 can read and/or write data to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120), printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the process of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 5 can be included in computer system 100. However, if computer system 100 comprises a handheld device or the like, it is understood that one or more external devices/resources 116 (e.g., display 120) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is a Floating Logo System 130 for managing a mobile device graphic user interface (GUI) image that allows for a “floating” logo, in accordance with embodiment(s) of the present invention. The Floating Logo System 130 generally may include a User Adjustment System 132 for allowing a user 104 to adjust a first image 10, as described above. The Memory 110 generally may include a Background System 134 and Application(s) 136 for allowing the use and adjustment of the background 6 and the application 8 on the mobile devices 2A-2×, as described above.

The present invention can be offered as a business method on a subscription or fee basis. For example, one or more components of the present invention can be created, maintained, supported, and/or deployed by a service provider that offers the functions described herein for customers. That is, a service provider can manage a mobile device graphic user interface (GUI) image that allows for a “floating” logo, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk-read only disk (CD-ROM), a compact disk-read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method of managing a mobile device graphic user interface (GUI) image, the method comprising:
providing a mobile device GUI, wherein the mobile device GUI is configurable to display at least one of a background image and an application image; and
displaying an independent image on the mobile device GUI in one of a plurality of pre-defined, user-selectable areas, wherein the independent image is independent of the background image and the application image.

2. The method of claim 1, wherein each of the pre-defined, user selectable areas comprises a unique portion of the mobile device GUI.

3. The method of claim 1, wherein the independent image is a glyph.

4. The method of claim 1, further comprising enabling a user to adjust at least one aspect of the independent image.

5. The method of claim 1, wherein the displaying includes displaying the independent image on a plurality of types of mobile device GUIs.

6. The method of claim 1, wherein the displaying includes overlaying the independent image above at least one of the background image or the application image.

7. The method of claim 1, wherein the independent image is a logo for one of a group consisting of: a service provider and an enterprise application.

8. The method of claim 7, further comprising:
overriding the logo with a user-adjustable image.

9. A system of managing a mobile device graphic user interface (GUI) image, the system comprising:
a mobile device GUI, wherein the mobile device GUI is configurable to display at least one of a background image and an application image; and
a system for displaying an independent image on the mobile device GUI in one of a plurality of pre-defined, user-selectable areas, wherein the independent image is independent of the background image and the application image.

10. The system of claim 9, further comprising a system for enabling a user to adjust at least one aspect of the independent image.

11. The system of claim 9, wherein the system for displaying includes a system for displaying the independent image on a plurality of types of mobile device GUIs.

12. The system of claim 9, wherein the system for displaying includes a system for overlaying the independent image above at least one of the background image or the application image.

13. The system of claim 9, wherein the independent image is a logo for one of a group consisting of: a service provider and an enterprise application.

14. The system of claim 13, further comprising:
a system for overriding the logo with a user-adjustable image.

15. The system of claim 9, wherein the each of the pre-defined, user selectable areas comprise a unique portion of the mobile device GUI.

16. A program product stored on a computer readable medium for managing a mobile device graphic user interface (GUI) image, the computer readable medium comprising program code configured to:
display an independent image on a mobile device GUI in one of a plurality of pre-defined, user-selectable areas, wherein the mobile device GUI is configurable to display at least one of a background image and an application image, and wherein the independent image is independent of the background image and the application image.

17. The program product of claim 16, further comprising program code configured to:
enable a user to adjust at least one aspect of the independent image.

18. The program product of claim 16, the program code for displaying an independent image configured to:
display the independent image of a plurality of types of mobile device GUIs.

19. The program product of claim 16, the program code for displaying an independent image configured to:
overlay the independent image above at least one of the background image or the application image.

20. The program product of claim 16, wherein the independent image is a logo from one of a group consisting of: a service provider and an enterprise application; and
the program code further configured to:
override the logo with a user-adjustable image.
